(19) United States
(12) Patent Application Publication
(10) Pub. No.: US 2015/0043239 A1
(43) Pub. Date: Feb. 12, 2015

(54) LAMP FOR VEHICLE AND VEHICLE HAVING THE SAME

(71) Applicant: Hyundai Mobis Co., Ltd., Seoul (KR)

(72) Inventor: Seong Yeon HAN, Yongin-si (KR)

(73) Assignee: Hyundai Mobis Co., Ltd., Seoul (KR)

(21) Appl. No.: 14/222,779

(22) Filed: Mar. 24, 2014

(30) Foreign Application Priority Data
Aug. 9, 2013 (KR) 10-2013-0095006

(51) Int. Cl. F21S 8/10

(52) U.S. Cl. CPC F21S 48/1283; F21S 48/115
USPC 362/520

(57) ABSTRACT

Provided is a lamp for a vehicle. The lamp includes: an LED array; and an aspherical lens disposed in front of the LED array, in which a first stepped portion is provided on a light incident surface of the aspherical lens, and a second stepped portion is provided on a light exit surface of the aspherical lens, thereby reducing a brightness difference between a central portion and both side portions of a lighting image, and preventing light blurring.

### CROSS-REFERENCE TO RELATED APPLICATIONS

This application claims priority to and the benefit of Korean Patent Application No. 10-2013-0095006 filed in the Korean Intellectual Property Office on Aug. 9, 2013, the entire contents of which are incorporated herein by reference.

### FIELD

The present invention relates to a lamp for a vehicle and a vehicle having the same, and more particularly, to a lamp for a vehicle, which uses a multi-array type LED array as a light source, and a vehicle having the same.

### BACKGROUND

Various types of bulbs have been used initially as a light source of a lamp for a vehicle. Recently, a light emitting diode (LED), which has excellent light conversion efficiency and a low amount of heat radiation, may be reduced in size and weight, and has a long lifespan, has been widely used as a light source.

In general, the LED has an advantage in that a color temperature of the LED is about 5,500 K, which is close to a color temperature of sun light, so as to greatly reduce eye strain that causes fatigue, and the LED has an advantage in that a size of the LED is small so as to increase a degree of design freedom when a lamp for a vehicle is designed.

An LED array is a type of a light source formed by mounting a plurality of LEDs, and may directly implement various beam patterns by selectively turning on the plurality of LEDs. Therefore, the LED array may be applied to a head lamp and a rear lamp of the vehicle so as to be effectively used to implement various beam patterns.

FIG. 1 is a lighting image of a lamp for a vehicle which uses an LED array as a light source, and FIG. 2 is an image illustrating light blurring of a lighting image of the lamp for a vehicle which uses the LED array as a light source.

Referring to FIG. 1, it can be seen that a light distribution pattern using an LED array is formed to elongate in a longitudinal direction. However, in a case in which the number of LEDs, which are aligned and disposed, is increased, and a length of the LED array is increased, light blurring occurs at a position far from a center CL of a lighting image, as illustrated by A of FIG. 2.

FIG. 3 is a lighting image of the lamp for a vehicle which illustrates a dark zone B of an LED.

Particularly, in the case of the lamp for a vehicle which uses the LED array, when the vehicle travels in a high-beam mode at night, light blindness to a driver in an oncoming vehicle may be prevented by turning off a part of the LEDs when the oncoming vehicle or a preceding vehicle comes in sight, but a difference in lighting image between a center portion and a portion far from the center portion markedly occurs due to the light blurring.

### SUMMARY

The present invention has been made in an effort to provide a lamp for a vehicle and a vehicle having the lamp, which may prevent light blurring from becoming greater at a position which is farther away from a center of a lighting image, when the LED array and the aspherical lens are used.

An embodiment of the present invention provides a lamp for a vehicle including: an LED array; and an aspherical lens disposed in front of the LED array, in which a first stepped portion is provided on a light incident surface of the aspherical lens, and a second stepped portion is provided on a light exit surface of the aspherical lens.

The LED array may include an upper array configured to produce a low beam, and a lower array disposed below the upper array and configured to produce a high beam.

The first stepped portion and the second stepped portion may be provided on a virtual extended line that is defined by extending a boundary line between the upper array and the lower array.

Another embodiment of the present invention provides a vehicle including the aforementioned lamp for a vehicle.

According to the lamp for a vehicle and the vehicle having the lamp according to the embodiment of the present invention, the stepped portions are formed on the light incident surface and the light exit surface of the aspherical lens so as to improve uniformity of light distribution, thereby reducing a brightness difference between a central portion and both side portions of a lighting image, and preventing light blurring.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a lighting image of a lamp for a vehicle which uses an LED array as a light source.

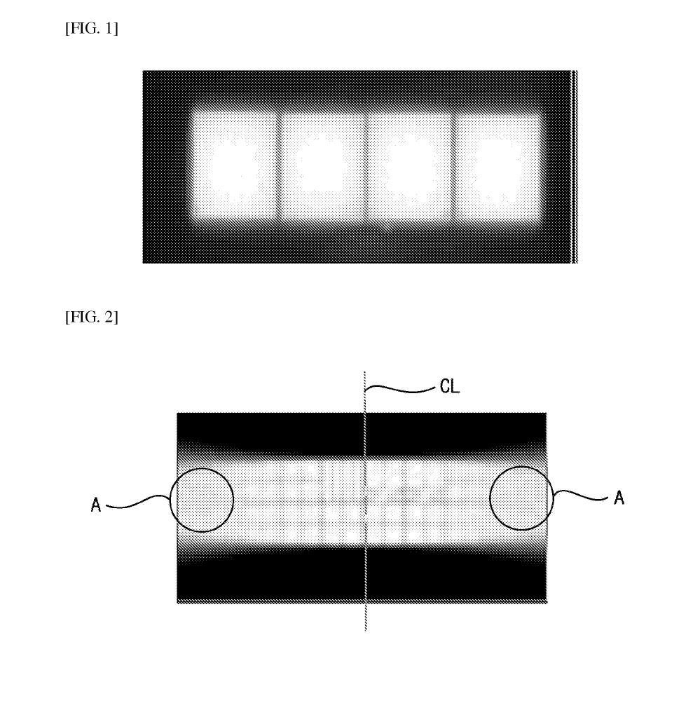

FIG. 2 is an image illustrating light blurring of a lighting image of the lamp for a vehicle which uses the LED array as a light source.

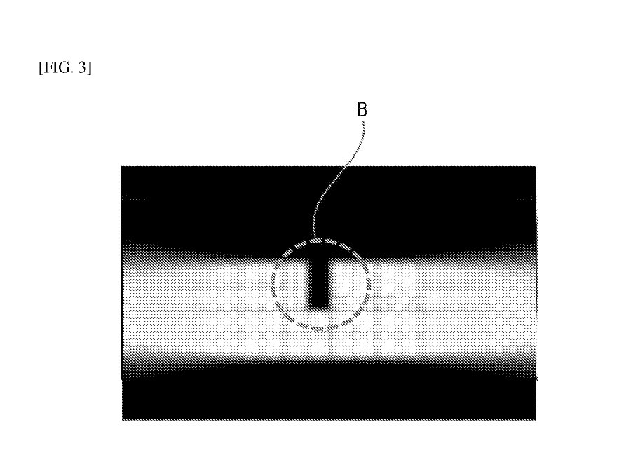

FIG. 3 is a lighting image of the lamp for a vehicle which illustrates a dark zone of an LED.

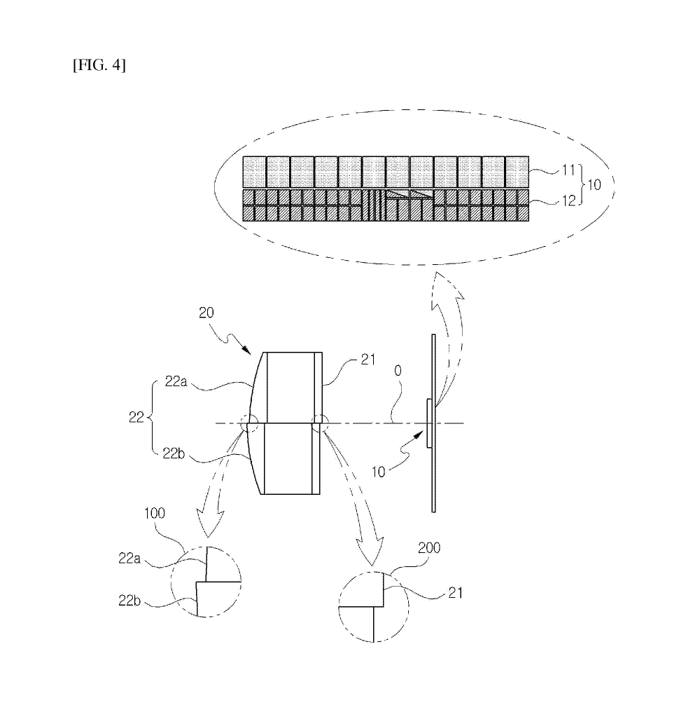

FIG. 4 is a view illustrating a lamp for a vehicle according to an embodiment of the present invention.

FIGS. 5 and 6 are views that compare a light distribution scan result of an aspherical lens, which has no stepped portion, with a light distribution scan result of an aspherical lens which has a stepped portion.

FIG. 7 is an image illustrating a lighting image in which the dark zone and light blurring are improved by the lamp for a vehicle of FIG. 4.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, an embodiment of the present invention will be described in detail with reference to the accompanying drawings. First, in denoting reference numerals to constituent elements of respective drawings, it should be noted that the same elements will be designated by the same reference numerals although they are shown in different drawings. Hereinafter, an embodiment of the present invention will be described, but, of course, the technical spirit of the present invention is not restricted or limited thereto, but the embodiment of the present invention may be modified by a person with ordinary skill in the art to be variously performed.

The embodiment has technical features in that uniformity of light distribution is improved by forming stepped portions on a light incident surface and a light exit surface of an aspherical lens.

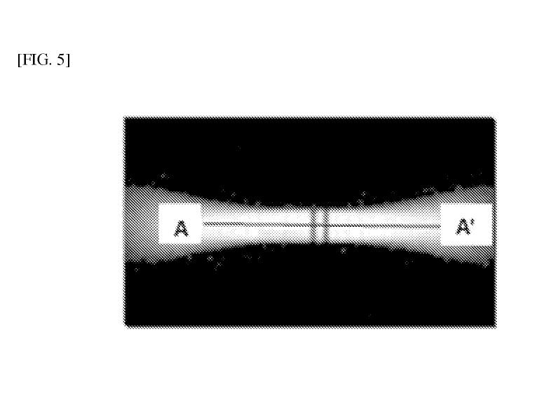

FIG. 4 is a view illustrating a lamp for a vehicle according to an embodiment of the present invention. FIG. 4 clearly illustrates only a main characteristic part for conceptual and clear understanding of the present invention. As a result, various modifications to the illustrations are expected, and the scope of the present invention is not limited to specific shapes illustrated in the drawings.

Referring to FIG. 4, according to a lamp for a vehicle according to an embodiment of the present invention, a first stepped portion 100 and a second stepped portion 200 are provided on a light incident surface 21 and a light exit surface 22 of an aspherical lens 20, respectively. The first stepped portion 100 and the second stepped portion 200 serve to improve uniformity of light distribution so as to reduce a brightness difference, which is caused by light blurring, between a central portion and both side portions of a lighting image.

An LED array 10 may include an upper array 11 configured to produce a low beam, and a lower array 12 configured to produce a high beam. The lower array 12 is disposed below the upper array 110.

The first stepped portion 100 and the second stepped portion 200 may be provided on a virtual extended line O that is formed by extending a boundary line between the upper array 11 and the lower array 12.

The first stepped portion 100 partitions the light exit surface 22 of the aspherical lens 20 into an upper surface 22a and a lower surface 22b. Here, the upper surface 22a and the lower surface 22b are also formed as an aspherical surface.

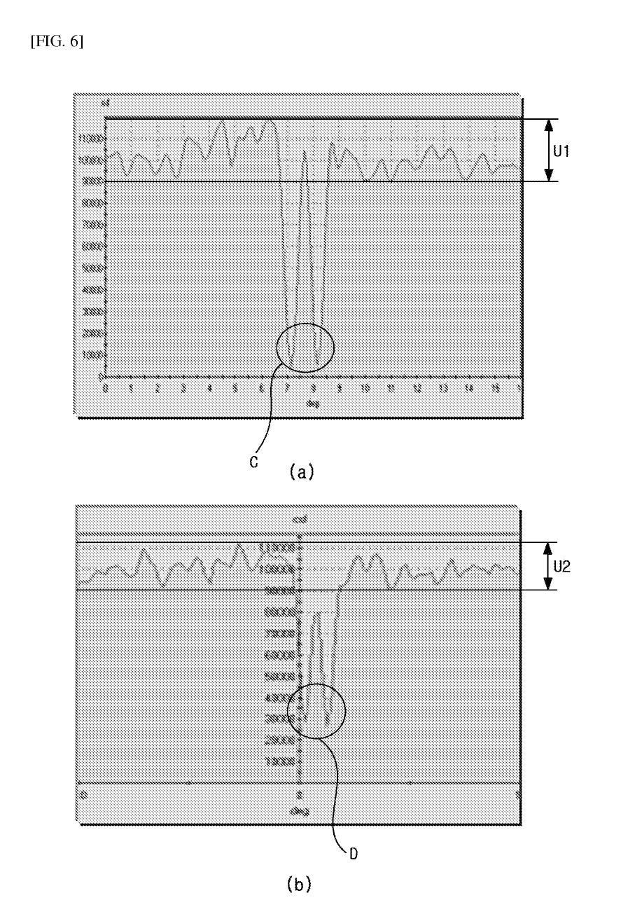

FIGS. 5 and 6 are views that compare a light distribution scan result of an aspherical lens, which has no stepped portion, with a light distribution scan result of an aspherical lens which has a stepped portion.

As a result of light distribution scanning of a lighting image of the lamp for a vehicle which is illustrated in FIG. 5 based on a line A-A′, there is a great difference in uniformity of light distribution between an aspherical lens in which no stepped portion such as the first stepped portion 100 and the second stepped portion 200 is provided on the light incident surface and the light exit surface, and an aspherical lens that has a stepped portion.

FIG. 6A is a graph illustrating light distribution of an aspherical lens which has no stepped portion, and FIG. 6B is a graph illustrating light distribution of an aspherical lens which has a stepped portion such as the first stepped portion 100 and the second stepped portion 200. When comparing FIGS. 6A and 6B, it may be confirmed that light distribution U2 of FIG. 6B is more uniform than light distribution U1 of FIG. 6A. As illustrated by C of FIG. 6A and D of FIG. 6B, it may be confirmed that a sharpness difference of a dark zone shown in a central portion is also reduced in FIG. 6B than in FIG. 6A.

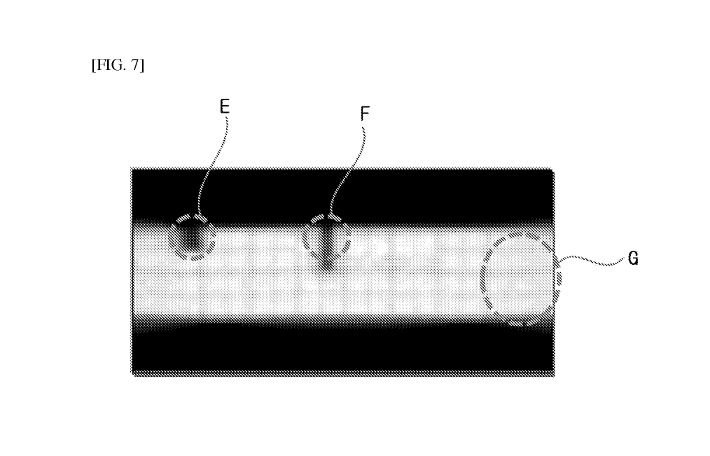

FIG. 7 is an image illustrating a lighting image in which the dark zone and the light blurring are improved by the lamp for a vehicle of FIG. 4.

As illustrated by E and F of FIG. 7, it can be seen that, in a lighting image which is implemented by applying the aspherical lens 20 having the first stepped portion 100 and the second stepped portion 200, ratios of an amount of light when light is turned off with respect to an amount of light when light is turned on are 13% and 26%, and as a result, sharpness of the dark zone is reduced. As illustrated by G of FIG. 7, it can be seen that light blurring is reduced.

As described above, the embodiments have been described and illustrated in the drawings and the specification. The embodiments were chosen and described in order to explain certain principles of the invention and their practical application, to thereby enable others skilled in the art to make and utilize various embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A lamp for a vehicle, comprising:
an LED array; and
an aspherical lens disposed in front of the LED array, wherein a first stepped portion is provided on a light incident surface of the aspherical lens, and a second stepped portion is provided on a light exit surface of the aspherical lens.

2. The lamp of claim 1, wherein the LED array includes an upper array configured to produce a low beam, and a lower array disposed below the upper array and configured to produce a high beam.

3. The lamp of claim 2, wherein the first stepped portion and the second stepped portion are provided on a virtual extended line that is defined by extending a boundary line between the upper array and the lower array.

4. A vehicle comprising the lamp according to claim 1.
